(19) United States
(12) Patent Application Publication
(10) Pub. No.: US 2008/0318763 A1
(43) Pub. Date: Dec. 25, 2008

(54) SYSTEM FOR PRODUCTION AND PURIFICATION OF BIOFUEL

(76) Inventor: Greg Anderson, Takaka (NZ)

Correspondence Address: WILSON SONSINI GOODRICH & ROSATI, 650 PAGE MILL ROAD, PALO ALTO, CA, 94304-1050, US

(21) Appl. No.: 12/143,706

(22) Filed: Jun. 20, 2008

Related U.S. Application Data
(60) Provisional application No. 60/945,895, filed on Jun. 22, 2007.

(51) Int. Cl. B01J 20/34; B01J 20/00; B01J 19/00

(52) U.S. Cl. 502/33; 502/22; 502/34; 502/20; 502/56; 502/36; 422/198; 422/208

(57) ABSTRACT

Systems and methods are provided for the regeneration of adsorbent medium and the production of additional fatty acid esters, i.e., biofuel, in particular, by means of discharging adsorbed contaminants from an adsorbent medium such as an inorganic catalytic medium by methods that convert the contaminants into additional biofuel or biofuel intermediates, thereby increasing production efficiency, conserving labor, and reducing material waste and environmental contamination.

### RELATED APPLICATION

This application claims benefit of priority to U.S. Provisional Application 60/945,895 filed Jun. 22, 2007, the contents of which are incorporated herein by reference.

### FIELD OF THE INVENTION

This invention relates to production and purification of fatty acid esters, biofuel or biodiesel, and more particularly relates to regeneration and use of materials for purification of fatty acid ester materials.

### BACKGROUND OF THE INVENTION

In the production of fatty acid esters from fats or oils for use as biofuel, it is usually the case that undesirable contaminants result and remain in the reaction mixture, often at levels which exceed the limits established by regulatory bodies. Typically, these contaminants include unreacted triglycerides, reaction biofuel intermediates such as mono- and diglycerides, free fatty acids, glycerol, sulfur compounds, and residues of catalysts used for the synthetic sequence.

Historically, contaminants have been removed by means of extended water wash cycles, with subsequent drying of the fuel. This method involves the necessity of dealing with significant volumes of contaminated water, and of drying the wet fuel in order to meet regulatory standards for water content. In recent years, this method has been decreasing in favor, and the industry has adopted systems using adsorbent materials to remove the contaminants. These adsorbents are typically of two varieties, polymeric resins and mineral adsorbents. The mineral adsorbents are intended to be disposed of after reaching maximum adsorbent capacity. Manufacturers of certain resin adsorbents indicate that they may be regenerated, however this practice often entails the use of additional chemical reagents. After a finite number of cycles these adsorbent products become saturated or otherwise permanently fouled, and cannot be reactivated, but must, instead, be disposed of or composted.

In recent years there has been increasing interest in the use of heterogeneous catalysis and supercritical methods for fatty acid ester production. The presence of free fatty acids in the fuel at levels exceeding regulatory limits is a common occurrence. These compounds are particularly difficult to remove, as they tend to co-distill with the desired esters, and then must be washed from the fuel by means of alkaline solutions, adsorbed onto disposable materials, which also retain significant quantities of valuable fuel, or removed with ion exchange resins, which require chemical regeneration. All of these techniques are wasteful in that extraneous chemicals are involved, and disposal of solutions and/or spent fuel saturated adsorbents is required.

Due to the relatively low value of the fuel product, more efficient processes and systems are needed to remove these contaminants to meet regulatory analytical and commercial standards while creating fuel product in an economical manner.

### SUMMARY OF THE INVENTION

The invention provides innovative methods and systems for the use and regeneration of materials used for purification of fatty acid ester materials (commonly known as “biodiesel” or “biofuels”), produced during or after an esterification or transesterification process, by means of reversible adsorption of starting-material and process-derived contaminants onto an adsorbent medium, in particular, an inorganic medium. In particular, it has been discovered that process-derived fatty acid contaminants, as well as the other process and pre-process contaminants in the ester fuel can be effectively removed by use of certain metal oxides and silicates, and by use of the regeneration methods and systems of the invention, can be directly converted into additional biofuel.

Other goals and advantages of the invention will be further appreciated and understood when considered in conjunction with the following description and accompanying drawings. While the following description may contain specific details describing particular embodiments of the invention, this should not be construed as limitations to the scope of the invention but rather as an exemplification of preferable embodiments. For each aspect of the invention, many variations are possible as suggested herein that are known to those of ordinary skill in the art. A variety of changes and modifications can be made within the scope of the invention without departing from the spirit thereof.

### INCORPORATION BY REFERENCE

All publications and patent applications mentioned in this application are herein incorporated by reference to the same extent as if each individual publication or patent application was specifically and individually indicated to be incorporated by reference.

### BRIEF DESCRIPTION OF THE DRAWINGS

The invention may be more completely understood in connection with the following drawings, in which:

FIG. 1 is a schematic view of a method of producing and purifying fatty acid esters as biofuel.

FIG. 2 is a schematic view of a method of regenerating spent adsorbent materials and generating additional fatty acid ester intermediates and biofuel intermediates in accordance with an embodiment of the invention.

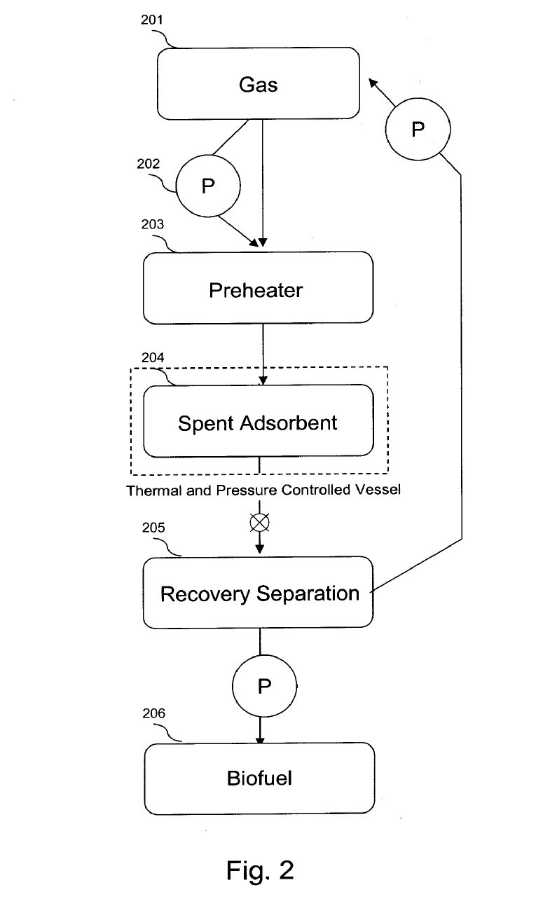

FIG. 3 is a schematic view of a method of generating additional fatty acid esters and biofuel intermediates in accordance with another embodiment of the invention.

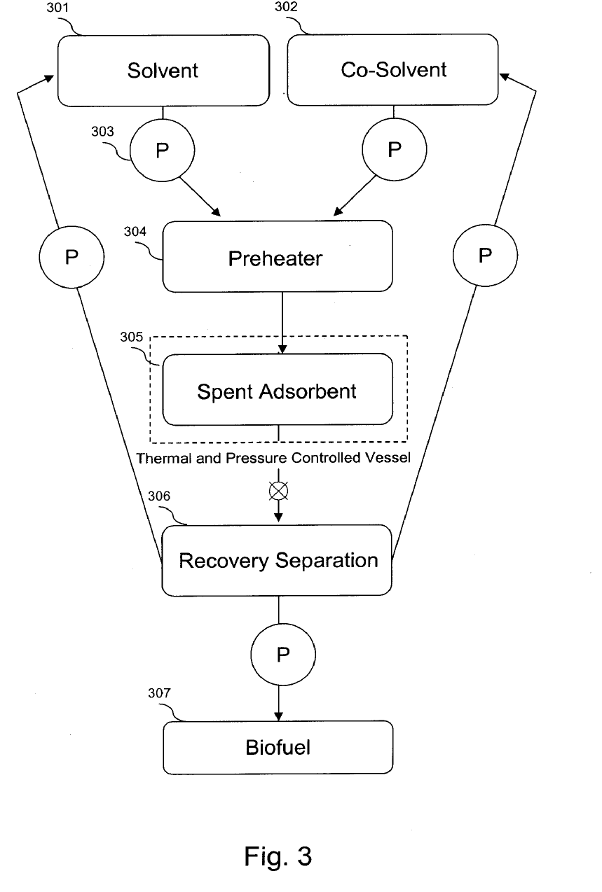

### DETAILED DESCRIPTION OF THE INVENTION

While preferred embodiments of the invention have been shown and described herein, such embodiments are provided by way of example only. Numerous variations, changes, and substitutions will now occur to those skilled in the art without departing from the invention. It should be understood that various alternatives to the embodiments of the invention described herein may be employed in practicing the invention.

The invention includes novel methods and systems for the repetitive regeneration of adsorbent media used in the production and purification of fatty acid ester materials whereby additional biofuel or biofuel intermediates are produced and recovered, thereby increasing production efficiency, conserving labor, and reducing costs, material waste and environmental contamination. As described above, fatty acid esters are produced from fats or oils in reactions that produce contaminants that must be removed in order to produce biofuel that meets regulatory standards. The methods and procedures herein to make such fatty ester biofuels may be applied to various vessels and known methods for synthesis of biofuel such as those described in U.S. application Ser. No. 12/143,724 filed on Jun. 20, 2008, incorporated by reference herein in its entirety.

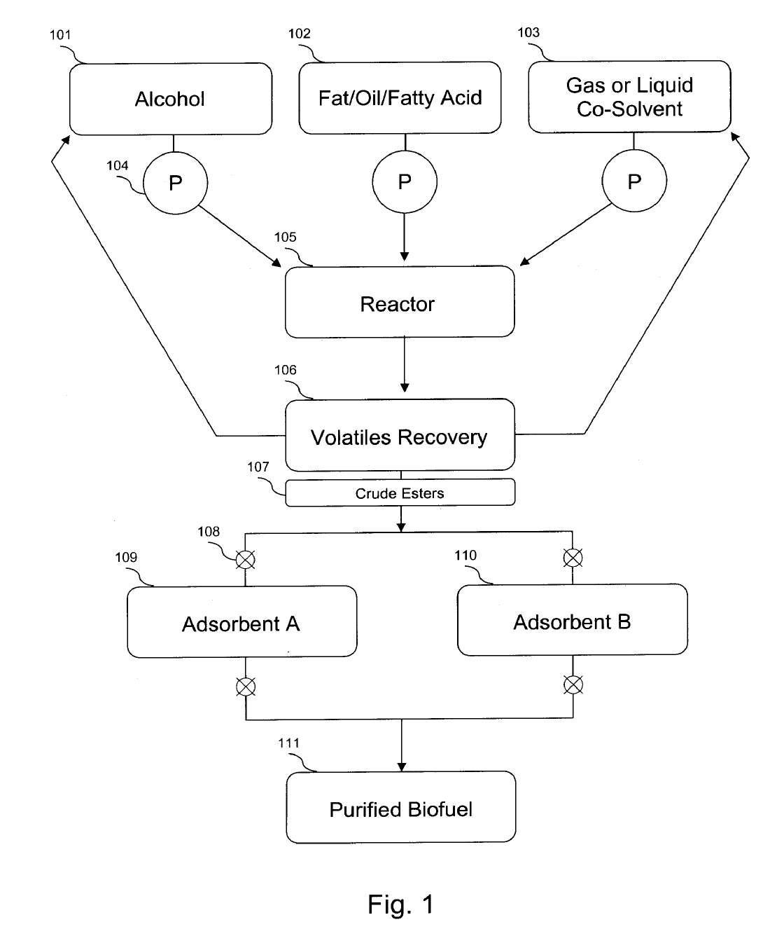

A schematic view of an exemplary batch process to produce biofuel is shown in FIG. 1, wherein starting fats, fatty acids, or oils 102 are pumped 104 with alcohol 101 and optionally with gaseous or liquid co-solvents 103 into a reactor 105 and reacted using conditions promoting transesterification and esterification, including the use of catalysts. After producing the crude esters 107, the volatiles 106 may be recovered and recycled, while the crude esters are purified by passing them 108 through one 109 or more 110 adsorbent media 109, 110 and recovering purified esters 111 by distilling, eluting or otherwise recovering the biofuel.

During the purification contaminants are adsorbed onto the adsorbent materials until their capacity is saturated and the adsorbent medium is spent.

It has been discovered that alkyl esters may be economically produced and purified using metal oxides and metal silicates that function as heterogeneous catalysts. Heterogeneous catalysts offer various advantages including the ability to conduct transesterifications and esterifications simultaneously while regenerating the adsorbent medium.

### Methods

In one aspect of the invention, methods are provided for purifying biofuel, comprising: providing a reaction mixture containing fatty acid ester and intermediate contaminants; passing the mixture thorough an adsorbent medium for absorbing non-fatty acid ester contaminants, thereby purifying the fatty acid ester; and treating the spent adsorbent medium to discharge the contaminants and regenerate the adsorbent medium so that it may be repeatedly re-used for the purification of biofuel.

In one embodiment, the adsorbent medium is an inorganic adsorbent medium that adsorbs intermediate contaminants such as those found in fatty acid ester process streams of the transesterification and/or esterification reaction.

In a further embodiment, the inorganic adsorbent medium possesses catalytic activity, which manifests during the regeneration process, and provides for conversion of adsorbed intermediate contaminants to produce additional fatty acid ester.

As examples of the embodiments, the adsorbent medium comprises oxides and silicates of aluminum, magnesium, silicon, hafnium, yttrium, titanium, or zirconium, either singly or in combination.

In one embodiment, the reactivation may be accomplished by pumping 303 gas or a fluid solvent 301 through a preheater 304, to thermally-enhance the solvent's extractive strength, and contacting the solvent with the spent adsorbent medium in a thermally-controlled vessel 305. Preferably, reactivation is effected by a gas or fluid solvent in a near-critical or supercritical condition. In this embodiment, adsorbed substances are effectively removed and can be recovered and reincorporated into a biofuel synthetic scheme, increasing final product yields.

In other embodiments, the reactivation may be accomplished by pumping 303 a gas or liquid solvent 301 and a gas or fluid co-solvent 302 through a preheater 304 and contacting the spent adsorbent medium with the solvent mixture in a thermally-controlled vessel 305. Preferably, reactivation is effected by solvents and co-solvents in a near-critical or supercritical condition.

The supercritical reaction conditions referred to herein may refer to the following. Fluids in the supercritical condition show a behavior different from the normal states of liquid or gas. The critical properties of commonly-used supercritical fluids are shown in Table 1 (Reid et al, 1987, incorporated by reference herein). A fluid in the supercritical condition is a non-liquid solvent having a density approximate to that of liquid, a viscosity approximate to that of gas, and a thermal conductivity and a diffusion coefficient which are intervenient between those of gas and of liquid. Its low viscosity and high diffusion favor mass transfer therein, and its high thermal conductivity enables high thermal transmission. Because of such a special condition, the reactivity in the supercritical condition is higher than that in the normal gaseous or liquid state and thus esterification and/or transesterification is promoted. One of the most important properties of supercritical fluids is their solvating properties, which are a complex function of their pressure and temperature, independent of their density. The near-critical reaction conditions referred to herein result from temperatures generally greater than a temperature of about 0.7 relative to supercritical temperatures.

TABLE 1
Critical properties of various solvents (Reid et al., 1987)

| | Molecular | Critical | Critical | Critical |
|---|---|---|---|---|
| | weight | temperature | pressure | density |
| Solvent | g/mol | K | mPa (atm) | g/cm³ |
| Carbon dioxide | 44.01 | 304.1 | 7.38 (72.8) | 0.469 |
| (CO₂) | | | | |
| Water (H₂O) | 18.02 | 647.3 | 22.12 (218.3) | 0.348 |
| Methane (CH₄) | 16.04 | 190.4 | 4.60 (45.4) | 0.162 |
| Ethane (C₂H₆) | 30.07 | 305.3 | 4.87 (48.1) | 0.203 |
| Propane (C₃H₈) | 44.09 | 369.8 | 4.25 (41.9) | 0.217 |
| Ethylene (C₂H₄) | 28.05 | 282.4 | 5.04 (49.7) | 0.215 |
| Propylene (C₃H₆) | 42.08 | 364.9 | 4.60 (45.4) | 0.232 |
| Methanol (CH₃OH) | 32.04 | 512.6 | 8.09 (79.8) | 0.272 |
| Ethanol (C₂H₅OH) | 46.07 | 513.9 | 6.14 (60.6) | 0.276 |
| Acetone (C₃H₆O) | 58.08 | 508.1 | 4.70 (46.4) | 0.278 |

Thus, in one embodiment, the method comprises treating the adsorbent medium by contacting the adsorbent medium with a gas and/or liquid solvent at a temperature of between 150 degrees Celsius and about 475 degrees Celsius, or preferably at a temperature of between 250 degrees Celsius and about 450 degrees Celsius. In a further embodiment, the method comprises contacting the adsorbent medium with an alcohol, with or without an additional gas and/or liquid co-solvent at a temperature of between 150 and 475 degrees Celsius, or preferably at a temperature of between 250 and about 450 degrees Celsius.

In yet a further embodiment, the method additionally comprises treating the adsorbent medium by contacting the absorbent medium with the alcohol and/or solvent under pressures between 7 mPa and about 35 mPa, and preferably between about 10 mPa and about 30 mPa.

When using alcohols for the adsorbent material regeneration method embodiments, it may be highly preferable to employ alcohols of a type generally used in the original fatty acid ester generation process. In one embodiment, such alcohols include, but are not limited to methanol, ethanol, n-propanol, isopropanol, n-butanol, isobutanol, t-butanol, pentanol, hexanol, cyclohexanol, heptanol and the like. In preferred embodiments, the alcohol is methanol or ethanol. In another embodiment, alcohols for the regeneration methods are used together with gases, liquid solvents, or co-solvents such as carbon dioxide, sulfur dioxide, nitrous oxide, sulfur hexafluoride, hydrocarbons, ethers, esters, ketones, dialkyl carbonates, halogenated hydrocarbons, nitrogen, and other gases or fluids.

The use of these solvents and co-solvents under near-critical or supercritical conditions, in the presence of the catalytically-active adsorbent metal oxide or silicate medium of the embodiments, provides for the effective conversion of adsorbed contaminants such as glycerides and fatty acids into additional ester biofuels. In a preferred embodiment, the alcohol, under the influence of the catalytic adsorbent materials and conditions of elevated temperature and pressure, effectively reacts with such contaminants by means of esterification and transesterification reactions to create ester fuel. The alcohol can be employed either alone or simultaneously with a gaseous or liquid co-solvent.

Accordingly, it has been found that by flushing a vessel containing spent catalytic adsorbent medium with a fluid and/or gas solvents and co-solvents disclosed herein, preferably done under conditions of a near-critical or supercritical condition with treatment times of about one hour, the fluids or gas solvents can be readily separated and recovered 306, the contaminants discharged and either converted to additional biofuel or recovered as intermediates 307, depending on the selection of liquid or gaseous solvents selected, and the adsorbent bed can be rapidly reactivated and returned to service.

In another aspect, the absorbent medium may be effectively regenerated via thermal processes alone. In one embodiment, the regeneration process provides methods wherein a bed of spent adsorbent medium will regain complete adsorbent potential upon treatment at a temperature of about 200-600 degrees Celsius, or preferably about 250-450 degrees Celsius, or more preferably about 350-425 degrees Celsius, for a period of about 1 hour. In using these pyrolytic methods, a distillate is driven from the column, either by its own vapor pressure, or, in a preferred embodiment, by methods wherein a flowing stream of sweep gas 201, such as nitrogen or air, is pumped 202 through a preheater 203 and into the purification vessel 204 containing the bed of spent adsorbent medium, sweeping the adsorbent medium with the gas. By the methods of the embodiments, the contaminants are discharged from the flushed column of catalytic adsorbent medium and are essentially completely recoverable 205, and are substantially converted into the corresponding alkyl esters or hydrocarbon intermediates 206. As such, they may be re-incorporated into the generation process or used directly as biodiesel fuel, thereby increasing the efficiency of the process, the overall product yield, and improving the economics of biofuel production.

### Systems

Another aspect of the invention provides systems useful for the integration of the various components or equipment to facilitate or carry out the methods described herein. These systems may be modified for generating fatty acid esters and biofuel, purification of fatty acid esters, regeneration of adsorbent materials, and conversion of contaminants into fatty acid esters or similar suitable motor fuels.

In one embodiment, a system is provided for regenerating spent adsorbent medium and producing additional biofuel where a vessel that receives or contains spent catalytic adsorbent medium has one or more pumping devices attached to pump a solvent and optionally a co-solvent through a preheater device and into the vessel and into contact with the catalytic adsorbent medium under near-critical or supercritical conditions of temperature, pressure and density. In a further embodiment, the vessel is thermally- and pressure-controlled with pumps, valves, and thermal-regulating devices to maintain the near-critical- or supercritical conditions. Under such system conditions, the solvents are capable of reacting with contaminants adsorbed on the spent adsorbent medium and effect the catalytic conversion of contaminants into biofuel, discharging them for recovery, thereby regenerating the adsorbent medium. In yet another embodiment, the system is configured with a device configured to recover the solvents and biofuel separately, and a pumping device that is coupled to the vessel recirculates the recovered solvents from the first vessel to a second vessel. The system is also configured with another pump to transport the recovered biofuel from the first vessel to a third vessel.

In another embodiment, the system provides methods for the regeneration or reactivation of the catalytic inorganic adsorbent medium without the necessity of its removal from the process stream.

In a further embodiment, the system provides methods for the reactivation of the adsorbent medium in situ.

In preferred embodiments, the methods and systems herein may be coupled with any other known method or preexisting system for producing fatty acid esters or biofuel which generally involves a reaction between an oil and/or fat and an alcohol (transesterification) or fatty acid and an alcohol (esterification), preferably at or near supercritical reaction conditions. Such reactions may be carried out in various reaction modes, e.g., in a single vessel, in a batch system, or in a flow system, and integrated with the methods and systems disclosed herein. Thus, the systems and methods of this invention may be used to reactivate the adsorbent materials regardless of the reactor type that is used for the actual fuel synthesis process.

### Materials for Producing Biofuels by the Methods and Systems

Sources of oil-containing substance used in the esterification or transesterification reaction of the provided methods and systems include, but are not limited to, tallow of livestock such as lard tallow, chicken tallow, lamb tallow, butter fat, beef tallow, cocoa butter fat, corn oil, peanut oil, cotton seed oil, soybean oil, rapeseed oil, coconut butter, olive oil, safflower oil, coconut oil, oak oil, almond oil, apricot kernel oil, beef bone fat, walnut oil, castor oil, chaulmoogra oil, Chinese vegetable tallow, cod liver oil, cotton seed stearin, sesame oil, deer tallow, dolphin tallow, sardine oil, mackerel oil, horse fat, pork tallow, bone oil, linseed oil, mutton tallow, neat's foot oil, palm oil, palm kernel oil, porpoise oil, shark oil, sperm whale oil, tung oil, whale oil, agricultural crops, crop residues, grain processing facility waste, value-added agricultural facility byproducts, livestock production facility waste, livestock processing facility waste and food processing facility waste. In addition, the oil-containing substance may be a mixture of plurality of these oils or fats, may contain a diglyceride or a monoglyceride or a partly denatured oil or fat such as oxidized, reduced or others.

Furthermore, it may be an unpurified oil-containing substance containing a free fatty acid, water, or waste oil or fat discarded by restaurant, food industries or common homes. The oil-containing substance may contain other components that include, without limitation, crude oil, heavy oil, light oil, mineral oil, essential oil, coal, fatty acids, saccharides, metal powders, metal salts, proteins, amino acids, hydrocarbons, cholesterol, flavors, pigment compounds, enzymes, perfumes, alcohols, fibers, resins, rubbers, paints, cements, detergents, aromatic compounds, aliphatic compounds, soot, glass, earth and sand, nitrogen-containing compounds, sulfur-containing compounds, phosphor-containing compounds, halogen-containing compounds and the like.

When the oil-containing substances described herein have a possibility of participating in the reaction, for example, have a possibility of inhibiting the reaction, or they are solid and have a possibility of occluding in the process of production or other similar possibility, it is preferred to remove them by a treatment such as filtration, distillation or the like before the reaction.

The methods and systems provide that the oil-containing substances are reacted with an alcohol to produce a fatty acid ester. Examples of alcohols useful for the reaction include, but are not limited to, methanol, ethanol, n-propanol, isopropanol, n-butanol, isobutanol, t-butanol, pentanol, hexanol, cyclohexanol, heptanol and the like. In preferred embodiments, the alcohol is methanol or ethanol.

Representative fatty acid esters generated by the methods and systems of the current invention include, but are not limited to, esters of valeric acid, caproic acid, enanthic acid, caprylic acid, pelargonic acid, capric acid, undecylic acid, lauric acid, tridecylic acid, myristic acid, pentadecylic acid, palmitic acid, heptedecylic acid, stearic acid, nonadecanoic acid, arachic acid, behenic acid, lignoceric acid, cerotic acid, heptacosanoic acid, montanic acid, melissic acid, lacceric acid, crotonic acid, isocrotonic acid, undecylenic acid, oleic acid, elaidic acid, cetoleic acid, erucic acid, brassidic acid, sorbic acid, linoleic acid, linolenic acid, arachidonic acid, propriolic acid, stearolic acid, nervonic acid, ricinoleic acid, (+)-hydnocarpic acid, (+)-chaulmoogric acid and the like. Alcoholic residue of esters depends on the alcohol used. For, example, a methyl ester is obtained when methanol is used as the alcohol, and an ethyl ester is obtained when ethanol is used as the alcohol.

The biofuel production, purification, and/or regeneration methods and systems described herein provide an economical and environmentally-friendly means of handling wastes such as agricultural facility byproducts, livestock production facility waste, livestock processing facility waste and food processing facility waste, and reducing process-associated wastes while producing a renewable energy source at the same time. This renewable energy source may be used as a process load. In one embodiment, energy is generated in quantities sufficient to meet the steam load of a processing plant after start-up, without the need for any added auxiliary fuel. The energy produced may additionally or alternately be commercially sold and/or used to generate electricity. Alternatively, some or all of the biofuel may be sold, thus providing operational flexibility.

The methods and systems described herein not only provide a profitable means to dispose of production waste streams that meet the newer and more stringent environmental regulations, the resulting commodity, i.e., energy, may be used as an alternative power source to help reduce dependence on fossil fuels. Reducing dependence on fossil fuels, particularly on foreign oil supplies, is of particular importance in the present turbulent political and economic climate. Additionally, with energy demands expected to increase significantly in the future, use of renewable energy sources will become increasingly important.

The invention may be better understood with reference to the following examples. These examples are intended to be representative of specific embodiments of the invention, and are not intended as limiting the scope of the invention.

### EXAMPLES

### Example 1

### Adsorption of Glycerol Contaminants on Silicon Dioxide

This Example demonstrates the ability of amorphous silicon dioxide to adsorb contaminating glycerol from a typical fatty acid methyl ester “biodiesel” stream.

Glycerol-saturated sheep tallow methyl ester, prepared by alkali catalyzed transesterification, was passed through a silica preparative column (Strata 83-S012-HBJ) that consisted of a 3 ml polypropylene tube containing 500 mg of 70 A 55 um amorphous silica, and successive eluate samples were collected (total volume of 26 ml).

The glycerol content of the starting material and samples of eluate was measured using the spectroscopic technique of Bondioli and Bella, European Journal of Lipid Science and Technology, vol. 107, p. 153 (2005), which employs periodate oxidation of glycerol to formaldehyde, condensation with ammonia and 2,4-pentanedione, followed by spectrophotometric analysis with a sensitivity of 2 ppm glycerol.

The results of the analyses are presented in Table 2. The effectiveness of silica in reducing the glycerol contaminant levels was established in that over 50 bed volumes of ester had been added to the column and yet the glycerol level of the eluate remained well within the limit of 200 parts per million currently established by world regulatory agencies.

TABLE 2
Analysis of Glycerol from Eluate of Silica Column

| Milliliters | Corresponding | |
|---|---|---|
| Eluate | Bed volumes | Glycerol |
| Collected | Collected | (ppm) |
| Start | | 1632 |
| 6 | 8 | 0 |
| 15 | 20 | 18 |
| 26 | 34 | 48 |
| 39 | 52 | 57 |

### Example 2

### Adsorption of Glycerol and Monoglycerides Contaminants on Silicon Dioxide

In order to test the ability of a metal oxide adsorbent to remove glyceride contaminants the following experiment was conducted.

To a borosilicate glass 10 ml dispensing pipette was added a small plug of quartz wool followed by approximately 3 grams of Davisil silica (60 A pore size, 550 m2/g surface area, 60-200 um particle size, 430 g/l density). A mixture of fatty acid methyl esters, produced from the reaction of nearly equivalent volumes of canola oil and methanol under supercritical conditions was added to the headspace of the pipette and allowed to percolate the bed under applied nitrogen pressure of 40 kPa. The ester mixture was replenished as required in order that 20 ml of eluate could be collected.

Samples of 0.1 gram of the starting material and the eluate were silated with 0.5 ml of a 9:3:1 solution of pyridine:hexamethyldisilazane:timethylchlorosilane (30 minutes, 75° C.) then were analyzed on a HP 1 silicone column in a 6890 HP Agilent GCMS chromatograph system.

In order to maximize accuracy in quantifying the presence of glycerol and mono-olein (the most prevalent monoglyceride from canola oil reactions) four target ions were selectively monitored, these being of mass 397 and 147 (typical of mono-olein) and 73 and 218 (typical of glycerol).

Table 3 represents the ion abundance for the untreated ester starting sample and for the eluate as collected after adsorbent treatment.

TABLE 3
Analysis of Contaminants

| | | | Abundance (units) |
|---|---|---|---|
| | Target | Starting | Post-silica |
| Compound | ions | Sample | Eluate |
| Mono-olein | 147/397 | 14200 | 30 |
| Glycerol | 73/218 | 64330 | 160 |

There can be seen a reduction of over 99.7% glycerol content and a 99.8% reduction of monoglyceride content. Additionally, the eluate was of very pale color and odor, whereas the crude ester was a dark brown material possessing a moderately acrid odor. Thus, the utility of the metallic oxide to effectively adsorb the glycerol contaminants was established.

### Example 3

### Adsorption of Free Fatty Acid on Aluminum Oxide

In this Example, the removal of free fatty acids was attempted. Fatty acids are a common contaminant resulting from the production of fatty acid alkyl esters via supercritical processes. They co-distill during traditional purification regimes and are particularly challenging to reduce to levels acceptable by international standards (acid number).

The adsorption capacity of activated alumina was determined using a glass chromatography column with 8 mm inside diameter and 200 mm length, containing 4.5 milliliters of Camag 507 neutral alumina (60 Angstrom pore diameter, 40-160 μm particle size, density 920 μl.) A crude mixture of fatty acid methyl esters (“biodiesel”), produced from the non-catalyzed reaction of roughly equal volumes of methanol and used cooking oil under supercritical conditions) was used to determine efficacy of contaminant removal. Using the silation and GCMS analysis methods of Example 2, the crude ester mixture was determined to contain 4.8% free fatty acid (w/w as oleic acid, sodium hydroxide titration) as well as 1.8% mono-/diglycerides. The mixture was added to the chromatography column, which was then pressurized with nitrogen to 50 kPa, thus providing for a flow rate of 0.11 bed volumes per minute.

Fractions were collected at convenient intervals and promptly titrated with a solution of 0.033N NaOH in 20 ml of isopropanol to the phenolphthalein endpoint. Three columns of similar character were tested in this way. Results from a typical experiment are presented in Table 4.

TABLE 4
Analysis of Free Fatty Acids from Eluate

| | | NaOH | % Fatty |
|---|---|---|---|
| | Collected | (ml) | acid |
| Fraction | weight (g) | per gram | as oleic |
| 1 | 0.817 | 0.12 | 0.11 |
| 2 | 0.794 | 0.12 | 0.11 |
| 3 | 0.818 | 0.12 | 0.11 |
| 4 | 0.902 | 0.22 | 0.20 |
| 5 | 0.824 | 0.24 | 0.22 |
| 6 | 0.503 | 0.30 | 0.28 |
| 7 | 0.561 | 0.34 | 0.32 |
| 8 | 0.538 | 1.44 | 1.34 |
| 9 | 0.579 | 2.06 | 1.92 |

Note 1:
The maximum allowable concentration of free fatty acid in biodiesel is approximately 0.25% (as oleic acid, EN 14214 and DIN V51606) and 0.4% (as oleic acid, ASTM D6751)
Note 2:
Combined samples 1 though 7 gave mono/diglyceride values of 0.3% (silation, GCMS), which is within the acceptable range for all international biodiesel quality standards.

The results demonstrate a “breakthrough” point at which the adsorbent becomes saturated and is no longer effective at fatty acid removal. This occurred after 5.2 grams of ester mixture had been collected from the column (Fractions 1-7). The alumina had adsorbed approximately 6% of its weight in fatty acid contaminants, and an undetermined amount of glycerides.

### Example 4

### Attempted Regeneration of Spent Adsorbent with Solvents at Ambient Temperature

The spent columns from Example 3 were treated successively with the following eluants, applied under 50 kPa nitrogen head pressure:

| | |
|---|---|
| Isopropanol | 10 ml |
| 95% Ethanol | 6 ml |
| Methanol | 10 ml |
| Hexane | 10 ml |

The solvents were followed by nitrogen flushing for 1 hour at 50 kPa pressure and 150° C. column temperature. The columns were allowed to cool under nitrogen flow, then challenged with the 4.8% free fatty acid containing methyl ester mixture exactly as in Example 3. Collected fractions were again titrated against sodium hydroxide solution. A typical result is illustrated in Table 5.

TABLE 5
Analysis of Fatty Acid Eluate

| | | | % Fatty |
|---|---|---|---|
| | Collected | ml NaOH | acid |
| Fraction | weight (g) | per gram | as oleic |
| 1 | 0.602 | 2.20 | 2.05 |
| 2 | 0.763 | 3.00 | 2.79 |

It is apparent that what may have been predicted to be a suitable ambient temperature solvent regeneration scheme does not return the adsorbent to its initial adsorptive capacity.

### Example 5

### Alumina Adsorption Column Capacities

139 g of Camag 507 neutral alumina, 60 Angstrom pore diameter, 40-160 μm particle size, 150 m²/g surface area, was poured into a 25 mm I.D.×500 mm length glass chromatography column. The adsorbent was saturated with typical biodiesel impurities by passage of 800 ml of a mixture of mixed fatty acid methyl esters, containing 2.8% free fatty acids (by titration), 0.08% glycerol (Bondioli and Bella technique of Example 1), and 1.3% mono/diglycerides (GCMS). This mixture had been created by reaction of nearly equivalent volumes of methanol and low grade poultry fat under supercritical conditions. After passage of the 800 ml of crude methyl esters, the output from the column was assayed and found to contain, by the aforementioned analytical techniques, nearly the same levels of fatty acid and glycerides as the input material. Thus, the adsorptive capacity was saturated and the medium was spent. The fatty acid ester blend was applied to the column under 75 kPa nitrogen head pressure, resulting in a flow of approximately 0.8 bed volumes per hour. The column was then rinsed with 2 bed volumes of hexane, under 75 kPa nitrogen head pressure to recover additional ester. Nitrogen flow was allowed to continue for 3 minutes.

The column was weighed and found to contain 177 grams of “wet” adsorbent, indicating retention of 38 grams of adsorbed material.

The column contents were emptied into a tarred borosilicate dish and heated in air at the following temperatures: 75° C. for 1 hour, 95° C. for 45 minutes, then 110° C. for 3 hours. The dish was weighed and it was found that the adsorbent had lost 18 grams of volatiles, or nearly 13% of the initial alumina column loading. The adsorbent still retained 20 grams of contaminant substances, or 14.3% of the initial column loading, demonstrating the adsorptive potential of alumina for biofuel contaminants.

### Example 6

### Pyrolytic Distillation of Spent Adsorbent

A 3.1 gram aliquot of the spent adsorbent from the previous Example was placed in a 25 ml round bottom flask, connected via short path distillation adapters to a 25 ml round bottom receiving flask. A type K thermocouple was used for measurement of the adsorbent temperature. Heat was applied by means of a gentle brush propane flame to the flask containing the adsorbent. At a temperature of 210° C., fuming commenced and at 280° C. condensation of a yellow liquid began. The distillation was allowed to continue until a temperature of 450° C. had been reached. At this point, the adsorbent had acquired a brown charred appearance.

The collected distillate was combined with 2×10 ml hexane washings of the adsorbent residue. A 0.1 ml aliquot of this mixture was silated with 0.5 ml of a 9:3:1 solution of pyridine:hexamethyldisilazane:timethylchlorosilane (30 minutes, 75C) then analyzed on a HP 1 silicone column in a 6890 HP Agilent GCMS chromatograph system.

The material consisted of roughly equal proportions of C9-C18 alkenes, fatty acid methyl esters, and free fatty acids, with other minor components. No mono- or diglycerides were observed.

The alkenes and fatty acid methyl esters present in this distillate are known to be completely suitable as motor vehicle fuels and the free fatty acids can be readily converted, by means of many techniques well know to those skilled in the art, including the aforementioned supercritical reaction techniques, to additional ester-type biofuels. Thus, the pyrolytic regeneration method is suitable for regeneration of the spent adsorbent medium and recovery of biofuel and intermediates.

### Example 7

### Pyrolytic Regeneration of Alumina Adsorbent

A 25.7 gram aliquot of the low temperature baked spent alumina from Example 6 was pyrolyzed in air in an open tarred borosilicate dish, in a moderate temperature oven equipped with silica view port. The oven temperature was ramped at a rate of roughly 2 degrees Centigrade per minute after an initial 10 minute hold time.

Observations are noted in Table 6

TABLE 6
Observations of Pyrolysis Sample

| Elapsed time | Oven temperature | Sample weight | |
|---|---|---|---|
| (min) | (Centigrade) | (grams) | Observation |
| 0 | 306° | 25.72 | Start |
| 10 | 310° | Not | Smoking begins |
| | | Determined | |
| 60 | 404° | 22.32 | No smoke, cinnamon |
| | | | color |
| 128 | 418° | 22.19 | No smoke, buff color |

The net loss of volatiles was 3.53 g or 13.72% of initial adsorbent weight.

Further heat treatment of a 10 gram aliquot of this material at a temperature of 490C for 1 hour resulted in complete decolorization and loss of only an additional 0.10% of initial weight. The results demonstrate the ability to regenerate adsorbent medium using only pyrolysis methods.

### Example 8

### Re-Use of Pyrolytically Regenerated Adsorbent

A 4.5 ml sample of the pyrolytically regenerated alumina from Example 7 (after 128 minutes of treatment and 418° C. maximum temperature) was added to the 8 mm inside diameter glass column, as described in Example 3. In the same manner of experimentation, a 4.8% free fatty acid containing methyl ester blend was passed through the column under 50 kPa nitrogen head pressure. The flow rate was 0.12 bed volumes per minute. Sample fractions were again weighed and titrated against 0.033N NaOH as described in Example 3. The results are presented in Table 7.

TABLE 7
Analysis of Free Fatty Acids from Eluate

| | | ml of | % Fatty |
|---|---|---|---|
| | Collected | NaOH | acid |
| Sample | weight (g) | per gram | as oleic |
| 1 | 0.761 | 0.10 | 0.09 |
| 2 | 0.735 | 0.10 | 0.09 |
| 3 | 0.804 | 0.13 | 0.12 |
| 4 | 0.834 | 0.21 | 0.20 |
| 5 | 0.779 | 0.24 | 0.22 |
| 6 | 0.640 | 0.29 | 0.27 |
| 7 | 0.612 | 0.34 | 0.32 |
| 8 | 0.576 | 1.47 | 1.37 |
| 9 | 0.524 | 1.98 | 1.84 |

The results demonstrate that the adsorptive capacity of the thermally-regenerated adsorbent is very similar to the fresh material used in Example 3, with the “breakthrough” point occurring after nearly 5.2 grams of collected samples. The results confirm the utility of the pyrolysis regeneration method.

### Example 9

### Regeneration Using Sweep Gas at Elevated Temperature

A 316 alloy stainless steel tube with inside diameter of 12 mm and length of 1100 mm, fitted with a stainless steel filter frit at the outlet, was filled with about 100 grams of adsorbent mixture consisting of a “plug” of 15 grams of Davisil silica (60 A pore size, 550 m2/g surface area, 60-200 μm particle size, 430 g/l density) at the inlet end, followed by 85 grams of Camag 507 neutral alumina (60 Angstrom pore diameter, 40-160 μm particle size, 150 m²/g surface area). The adsorbent column was configured in a “U” shape, and was cast into a bed of tin metal, contained in a stainless steel shell, and heated by thermostatically controlled band heaters. In this manner, the temperature of the tin bath and adsorbent cylinder could be adjusted as required.

At ambient temperature, the adsorbent was “loaded” by pumping crude biodiesel onto the column by means of an Eldex HPLC pump, at a rate of 10 ml/min. The biodiesel used was produced from used cooking oil by means of a supercritical transesterification regime, and containing 2.2% free fatty acids (NaOH titration, as oleic acid), 0.08% glycerol and 1.1% mono-diglycerides (silation, GCMS analysis).

The eluate was collected in a tarred flask, and a 0.1 ml aliquot from the first 100 grams of eluate was silated (0.5 ml of 9:3:1 pyridine:hexamethyldisilazane:trimethylchlorosilane (30 minutes, 75C) and analyzed with the GCMS system.

Only 0.09% free fatty acids (nearly all oleic) were found in the eluted sample, along with less than 0.01% glycerol and less than 0.01% monoglycerides (predominantly mono-olein).

An additional 300 ml of the crude biodiesel was run through the column at which point a 1 gram aliquot was analyzed and found to contain over 1.4% free fatty acid, measured as oleic, by NaOH titration in 25 ml of isopropanol, indicating that the adsorbent medium was saturated or “spent.”

At this point the adsorbent was regenerated by means of introducing a sweep gas and elevated temperature. A flow of dry nitrogen gas was initiated such that the flow rate measured at the outlet of the stainless tube was 30 ml/min (bubbled into inverted, water filled graduated cylinder). The tin bath jacket was heated to a temperature of 450° C., which in prior experiments resulted in an adsorbent temperature at or above 400° C. during the regeneration process. These conditions were maintained for one hour, after which the adsorbent U-tube was removed from the bath, and the contents allowed to cool.

The procedure of challenging the column with crude biodiesel, then regenerating under sweep gas/thermal treatment was repeated five times over a period of several days.

After the final regeneration treatment, a 0.1 ml aliquot was taken from the first 100 grams of eluate and analyzed as above.

This sample produced a reading of 0.10% free fatty acid (as oleic), 0.01% glycerol and 0.015% monoglycerides.

After flushing the column with 10 ml/min hexane for 25 min, the column was opened and the adsorbent medium rinsed out with hexane into a tarred borosilicate dish. The adsorbent medium was dark brown in color.

The absorbent medium was dried for 4 hours at 80° C., at which point the weight was 105 grams. This medium was additionally pyrolyzed for 4 hours at 460° C. in air using a medium temperature oven. After cooling, the white powder was reweighed, yielding 101 grams pyrolyzed product. The adsorbent medium had thus been restored to its initial weight after processing 25 bed volumes of crude fuel, demonstrating the utility of the sweep gas at elevated temperature method for regeneration of the adsorbent medium.

### Example 10

### Regeneration Using Near-Critical Liquid Carbon Dioxide

A 73.60 gram aliquot of the spent alumina adsorbent from the low temperature baking of Example 6 was used for this experiment. The adsorbent was placed in a 12 mm inside diameter by 800 mm length 316 stainless steel tube. The tube had a wall thickness of 2 mm and was fitted with a sintered stainless frit at the outlet end. The tube was connected, via 3 mm stainless tubing, to an Eldex HPLC pump for delivery of fluids, and a Go brand back pressure regulator to allow for adjustment of pressure within the tubing.

Liquid carbon dioxide was pumped through the system in an attempt to regenerate the spent alumina. The carbon dioxide was pumped at a rate of approximately 10 ml/min, at a temperature of 30° C. and a back pressure of 7.0 mPa, placing the conditions in the category of “near-critical”. The output from the back pressure regulator was vented through a side arm filter flask, then to atmosphere, while the flow was continued for a 15 minute period. The oily material collected in the filter flask from the carbon dioxide flushing was silated with 2 ml of 9:3:1 pyridine:hexamethyldisilazane:trimethylchlorosilane (30 minutes, 75° C.) and analyzed with the GCMS system to show the presence of approximately 85% mixed methyl esters of fatty acids and 15% mono- and diglycerides.

At this point the pump was stopped, the pressure released, and the alumina recovered from the tube. After drying at 80° C. for 2 hours in an oven, the weight of the alumina was 70.59 grams, indicating that 3.01 grams of adsorbed substances had been removed by treatment with the carbon dioxide.

The dried alumina was next subjected to pyrolysis, in a borosilicate dish, at 440 C for 4 hours in an air atmosphere. The resulting material was ivory colored and weighed 63.08 grams, indicating that 7.5 grams of additional adsorbed substances were driven from the adsorbent during pyrolysis. Thus, the recovery of adsorbed substances was incomplete by carbon dioxide flushing alone, indicating that the use of liquid carbon dioxide at near-ambient conditions was not completely effective in removing contaminants from the metal oxide adsorbent.

### Example 11

### Regeneration Using Supercritical Carbon Dioxide with Methanol Entrainer

Due to inadequate recovery of adsorbed substances under the influence of ambient temperature carbon dioxide, an experiment was conducted to improve adsorbent regeneration by addition of an entraining co-solvent and potential reactant, methanol.

A 316 alloy stainless steel tube with inside diameter of 12 mm and length of 1100 mm, and fitted with a stainless steel filter frit at the outlet was filled with about 100 grams of adsorbent mixture, consisting of a “plug” of 15.1 grams of Davisil silica (60 A pore size, 550 m2/g surface area, 60-200 um particle size, 430 g/l density) followed by 84.8 grams of Camag 507 neutral alumina (60 Angstrom pore diameter, 40-160 μm particle size, 150 m²/g surface area). As in Example 9, this adsorbent cylinder was connected, by means of 3 mm stainless steel tubing, to an Eldex triplex HPLC pump, for delivery of liquids at high pressure, and a Go back pressure regulator valve for system pressure control. The adsorbent column was configured in a “U” shape, and was cast into a bed of tin metal, contained in a stainless steel jacket, and heated by thermostatically controlled band heaters. In this manner, the temperature of the tin bath and adsorbent cylinder could be varied during the experiment.

The adsorbent was saturated with contaminants by passage, at a flow rate of 10 ml/min. and at ambient temperature, 400 ml of a crude biodiesel mixture. This methyl ester blend had been produced by means of transesterification/esterification with methanol under supercritical conditions. It was found in our laboratory to contain 2.2% free fatty acids (as oleic acid equivalent, NaOH titration) 0.08% glycerol (periodate, 2,4-pentanedione, ammonia reaction/spectrophotometry), and 1.1% mono- and diglycerides (silation, GCMS). This material was also found to contain 116 ppm sulfur (independent laboratory, ICPMS). The first 100 grams of eluate was collected from the column and tested. The results are presented in Table 8.

TABLE 8
Analysis of Column Feed and Eluate

| | Input % | Eluate % |
|---|---|---|
| Glycerol | 0.083 | 0.0094 |
| FFA | 2.24 | 0.10 |
| Mono-/Di- | 1.13 | 0.01 |
| glycerides | | |

Next, a blend of 2 ml/min of anhydrous methanol and 18 ml/min of liquid carbon dioxide was pumped, simultaneously, via two independent heads on the Eldex pump, through the adsorbent column. The system pressure was maintained at about 28 mPa and the temperature of the column was ramped from 30° C. to 300° C. over a period of 10 minutes, and held at 300° C. for 20 minutes. The column was then removed from the tin bath and allowed to cool to room temperature while maintaining fluid flow. The output of the back pressure regulator was captured in a 1000 ml side arm filter flask.

After completion of the run, a 1 ml aliquot of the residual material in the filter flask was dried in a 2 ml vial, under a stream of dry nitrogen, with swirling, for 10 minutes. It was then mixed with 0.5 ml of the silation reagent mixture as previously described. GCMS analysis of the aliquot indicated the presence of mixed fatty acid methyl esters as well as less than 2% each of free fatty acids and mixed mono- and di-glyceride contaminants. As such, the materials recovered from the regeneration process can be readily reincorporated into a fuel process stream for production of additional esters.

The column was again challenged with 400 ml of crude biodiesel, followed by the regeneration process described above. After eight repetitions of this sequence, a final challenge to the column was performed. In this case, the crude biodiesel was pumped through the column at the 10 ml/min flow rate, and 100 ml of eluate was collected for analysis. This material was sent to an independent analytical laboratory for a typical ASTM D6751 analysis. The relevant results are presented in Table 9.

After the last adsorbent column challenge, the contents of the adsorbent tube were removed with methanol rinsing and dried in a tarred borosilicate dish at 80C for 3 hours. Upon weighing, it was found that 99.7 grams of combined adsorbent was recovering, indicating that no significant quantity of residual contaminant remained.

It is apparent that the methods permit the repeated regeneration of the adsorbent medium that still enables the production of purified, quality fuel. This fuel would meet all requirements for diesel motor fuel as established in ASTM D6751 standards. Surprisingly, it was found that the regenerated adsorbent also possessed the ability to reduce sulfur to acceptable levels, in addition to reducing the free fatty acids and glycerides, making the present methods particularly useful in the production of biofuels. Indeed, the removal of sulfur from biofuels will become a significant challenge as lower grade feedstock materials are utilized in the future.

TABLE 9
Analysis of Biofuel Eluate

| | Level | Detection |
|---|---|---|
| Analysis | Found | Limit |
| Flashpoint | >150 | 4 |
| Water | n.d | 0.01 |
| Sulfur | 12 ppm | 0.5 |
| Acid number | n.d. | 0.05 |
| Free Glycerol | n.d. | 0.001 |
| Total glycerin | 0.01% | 0.001 |
| P, Mg | n.d | 1 ppm |
| Na, K, Ca | n.d. | 1 ppm |

Note:
n.d. indicates not detected

### Example 12

### Regeneration with Supercritical Methanol

In an attempt to regenerate the adsorbent media while simultaneously converting impurities to methyl ester fuel, under the catalytic influence of the metal oxide, the following experiment was conducted.

The 12 mm i.d. by 1100 mm long stainless tube described in Example 10 was used for this experiment. It was loaded with 100.1 grams of Camag 507 alumina, as previously described. The crude methyl ester biodiesel mixture employed in Example 11 (2.2% free fatty acid, 0.8% glycerol, 1.1% mono-/diglycerides) was treated by pumping through the column at a flow rate of 10 ml/min. Samples were taken at convenient intervals and titrated, using approximately 1 gram aliquots in 25 ml of isopropanol. Titration was against 0.029 N NaOH solution to a phenolphthalein endpoint.

The volume of eluate at which the titration value exceeded the equivalent of 0.6% oleic acid was considered to be the “breakpoint.” This occurred after 275 ml of eluate had been collected.

At this point the column was “blown down” with a flow of nitrogen (400 kPa) for 5 minutes (the material collected was not analyzed).

The column was then regenerated by pumping anhydrous methanol, against a back pressure of 26 mPa, at a flow rate of 4 ml/min, while the stainless column was maintained at a temperature of 380° C. by use of the thermostatically-controlled tin bath, as described in Example 10. The column outlet flow was cooled by means of a double loop of 3 mm stainless tubing, immersed in water, and located between the adsorbent column and the back pressure regulator valve. The cooled outlet material was then collected in a flask from the back pressure regulator outlet. After 10 minutes of methanol flow, the contents of the flask were recycled through the adsorbent column, instead of the fresh methanol. After 5 minutes, the methanol flow was reestablished to sweep out the adsorbent column, and this flow was continued for 10 minutes.

The pumping was discontinued and the column allowed to purge with nitrogen flow (50 kPa inlet pressure) for 15 minutes. At this point the column was removed from the heating bath and cooled to room temperature for further tests.

The collected methanol solutions from regeneration were rotary evaporated (Yamoto, 20 mmHg, 80° C. bath) and a 0.1 ml sample of the brown oily residue was silated with 0.5 ml of the previously described silation reagent. GCMS analysis indicated the presence of over 98% identifiable methyl fatty acid esters, and 0.1% of mono- and diglycerides. Titration of the methyl ester mixture indicated the presence of 0.4% free fatty acids (as oleic acid).

To determine the efficacy of the regenerated adsorbent column, the crude biodiesel challenge was repeated. Eight cycles of supercritical methanol regeneration followed by biodiesel adsorption challenge were repeated, and on the last cycle, the column “breakthrough” volume was determined as described above.

On this last challenge, the breakthrough volume was 285 ml, which is substantially unchanged from that of the first run.

Upon completion of the study the column contents were removed and weighed, as previously described. The recovered weight of 100.3 grams of adsorbent indicates that virtually no unchanged substances were retained on the regenerated adsorbent.

The adsorbed contaminants had been effectively converted to fatty acid methyl ester fuel under the conditions of regeneration, and could be readily purified, by passage through an adsorbent column to produce additional ester mixtures of high purity. These results confirm not only that the adsorbent column is able to be regenerated under conditions of methanol flushing at elevated temperature and pressure, but that the column eluate recovered from this regeneration technique possesses the necessary characteristics for use as a vehicular fuel.

By utilizing the aforementioned techniques, the production of fatty acid ester compounds of high purity may be accomplished without the need for one-time adsorbents, resulting in a more efficient process to remove the contaminants to meet regulatory analytical and commercial standards, and regenerate the adsorbent medium while creating fuel product in a more economical manner.

Although specific embodiments have been illustrated and described herein, it will be appreciated by those of ordinary skill in the art that any arrangement that is calculated to achieve the same purpose may be substituted for the specific embodiments shown. It is to be understood that the above description is intended to be illustrative, and not restrictive, and that the phraseology or terminology employed herein is for the purpose of description and not of limitation. Combinations of the above embodiments and other embodiments will be apparent to those of skill in the art upon studying the above description.

What is claimed is:

1. A method of regenerating spent adsorbent medium that produces additional biofuel, comprising:
selecting a spent adsorbent material that includes a catalyst and adsorbed contaminants;
flowing a solvent through the spent adsorbent material under near-critical or supercritical conditions; and
discharging the adsorbed contaminants as additional recoverable biofuel or biofuel intermediates while regenerating the adsorbent material.

2. The method of claim 1, further comprising simultaneously flowing a co-solvent through the spent adsorbent material under near-critical or supercritical conditions.

3. The method of claim 1, wherein the catalyst is selected from the group consisting of oxides of aluminum, magnesium, silicon, hafnium, yttrium, titanium, and zirconium.

4. The method of claim 1, wherein the catalyst is selected from the group consisting of silicates of aluminum, magnesium, silicon, hafnium, yttrium, titanium, and zirconium.

5. The method of claim 1, wherein the solvent is a fluid or a gas.

6. The method of claim 1, wherein the solvent is a C1-C5 alcohol.

7. The method of claim 1, wherein regenerating the adsorbent medium comprises contacting the catalyst with the solvent at a temperature of between 250 to about 450 degrees Celsius.

8. The method of claim 7, wherein regenerating the adsorbent medium further comprises contacting the catalyst with the solvent at a pressure of between 10 mPa to about 30 mPa.

9. The method of claim 2, wherein regenerating the adsorbent medium comprises contacting the catalyst with the solvent and the co-solvent at a temperature of between 250 to about 450 degrees Celsius.

10. The method of claim 9, wherein regenerating the adsorbent medium further comprises contacting the catalyst with the gas solvent and the co-solvent at a pressure of between 10 mPa to about 30 mPa.

11. The method of claim 2, wherein the co-solvent is selected from the group consisting of carbon dioxide, sulfur dioxide, nitrous oxide, sulfur hexafluoride, hydrocarbons, ethers, esters, ketones, alkyl carbonates, and halogenated hydrocarbons.

12. A method of regenerating spent adsorbent medium that produces additional biofuel, comprising:
selecting a spent adsorbent medium with adsorbed contaminants;
heating said spent adsorbent medium to a temperature of between 350 to about 450 degrees Celsius;
flowing a gas of nitrogen or air through the spent adsorbent material; and
discharging the adsorbed contaminants as additional recoverable biofuel or biofuel intermediates while regenerating the adsorbent material.

13. A system for regenerating spent adsorbent medium and producing additional biofuel, comprising:
a vessel for holding spent adsorbent medium that includes a catalyst;
a pumping device to direct a gas solvent through a preheater and into the vessel under near-critical or supercritical conditions, wherein the solvent is capable of reacting with contaminants adsorbed on the spent adsorbent medium; and
pressure and temperature control devices configured and operably coupled to the vessel for maintaining pressure and temperature conditions in the vessel such that the solvent is at or above a critical point of the solvent to convert the contaminants into biofuel and regenerate the adsorbent medium.

14. The system of claim 13, wherein the system comprises a device configured and operably coupled to the vessel to recover the solvent and biofuel separately.

15. The system of claim 13, wherein the system comprises:
a second pumping device to direct a co-solvent through a preheater and into the vessel under near-critical or supercritical conditions, wherein the solvent and the co-solvent are capable of reacting with contaminants adsorbed on the spent adsorbent medium; and
pressure and temperature control devices configured and operably coupled to the vessel for maintaining pressure and temperature conditions in the vessel such that the solvent and co-solvent are at or above a critical point to convert the contaminants into biofuel and regenerate the adsorbent medium.

16. The system of claim 13, wherein the vessel comprising the regenerated adsorbent medium is configured for the purification of biofuel from a solution containing biofuel and contaminants.

17. The system of claim 13, wherein the catalyst is selected from the group consisting of oxides of aluminum, magnesium, silicon, hafnium, yttrium, titanium, and zirconium.

18. The system of claim 13, wherein the catalyst is selected from the group consisting of silicates of aluminum, magnesium, silicon, hafnium, yttrium, titanium, and zirconium.

19. The system of claim 13, wherein the solvent is heated and maintained in the vessel at a temperature of between 250 to about 450 degrees Celsius.

20. The system of claim 19, wherein the solvent is pressurized and maintained in the vessel at a pressure of between 10 mPa to about 30 mPa.

21. The system of claim 15, wherein the solvent and co-solvent are heated and maintained in the vessel at a temperature of between 250 to about 450 degrees Celsius.

22. The system of claim 21, wherein the solvent and co-solvent are pressurized and maintained in the vessel at a pressure of between 10 mPa to about 30 mPa.
